(19) United States
(12) Patent Application Publication
(10) Pub. No.: US 2007/0033164 A1
(43) Pub. Date: Feb. 8, 2007

(54) ABAP utility program for assigning device types

(75) Inventor: Michael Marc Dubos, Wawona, CA (US)

Correspondence Address: PILLSBURY WINTHROP SHAW PITTMAN, LLP, P.O. BOX 10500, MCLEAN, VA, 22102, US

(73) Assignee: XEROX CORPORATION, Stamford, CT (US)

(21) Appl. No.: 11/167,132

(22) Filed: Jun. 28, 2005

(51) Int. Cl. G06F 17/30; G06F 17/00

(52) U.S. Cl. 707/3; 707/103 R

(57) ABSTRACT

A menu driven graphic user interface for configuring, creating and assigning device types using the SAP ABAP utility program.

### BACKGROUND

All references cited in this specification, and their references, are incorporated by reference herein where appropriate for teachings of additional or alternative details, features, and/or technical background.

Disclosed in embodiments herein is a menu driven graphic user interface for configuring, creating and assigning device types using the SAP ABAP utility program.

SAP is a business software package used by many major corporations in more than about fifty countries. It was developed by a German company based in Walldorf (founded in 1972) having the same name (an acronym for “Systeme, Anwendungen, Produkte in der Datenverarbeitung,” translated as “Systems, Applications, and Products in Data Processing”).

SAP R/3 is a version of the SAP application wherein three servers (e.g., presentation server, application server and database server), are located at different locations. SAP R/3 supports and simplifies business processes in a company. SAP R/3 is composed of optional modules to perform specialized functions, such as material management, finance, human resources, production, distribution and sales. As such, it is an “enterprise resource planning” (“ERP”) software product capable of integrating multiple business applications in real time mode. As a software-oriented multi-tier client/server open system, it may be employed on hardware systems including UNIX, OpenVHS, Windows NT and the AS/400, with application servers communicating with database servers across the network. SAP R/3 is particularly useful in allowing the presentation interface front end to run Windows, OS/2, USF/Motif and MacIntosh, and in permitting a variety of databases to be utilized, including Oracle, Informix, Sybase and Software AG.

The SAP R/3 architecture enables an uncoupling of the application logic from the presentation level and database, allowing for distribution of tasks in a client/server environment. Typically, a user logs on to the SAP system and calls a series of transactions in the application server through data entry panels, the transactions invoking programs which are interpreted by the R/3 routine system installed on every application server. When a request arrives to an application server, it is placed in its dispatcher queue and is not dispatched until a work process, the basic “working engine” within R/3, becomes free. SAP is highly configurable, secure, and helps minimize data redundancy while improving data consistency.

Advanced Business Application Programming Language (“ABAP”), a fourth generation programming language, is the programming language used by SAP for the development of all of its standard business applications, including SAP R/3. On top of ABAP, SAP provides a full-purpose development environment known as the ABAP development workbench, which allows users to develop their own solutions or extend capabilities of existing SAP applications, allowing programs, screens and menus to be produced by way of an object repository (storing development objects including programs, documentation, dictionary data, and dynamic programs) and data dictionary (describing the data structures used in programs). ABAP/4 allows SAP programmers considerable freedom in coding programs.

Software is necessary to control any hardware component or peripheral device (i.e., any machine or component (i.e., “device type”)) that attaches to a computer. The so-called “device driver” accesses the hardware registers of a device to allow the computer to control such a device.

Device drivers are provided along with devices, such as printers, to allow for their employment on a number of different computing systems, which may employ any number of different operating systems (that is, to provide control to the device). Among the many device drivers are those that allow for printing over any number of SAP-based systems.

Since October 2001, Xerox has provided a device type creation tool called “PSPro” that allows one to construct device drivers necessary for running a Xerox printer on a SAP system. The Xerox PSPro device type configuration tool is a SAP R/3 Postscript device type generator. The Graphic User Interface (“GUI”) software tool of PSPro enabled users to generate user defined SAP R/3 Postscript device types that contained special format types, SAP script print controls and SmartForms (that is, SAP forms)—based document development, without need of knowledge of Postscript PDL. PSPro was developed to handle all types of printers, including production printers, office printers and desktop printers. While providing users with easy selection of the type of printing system to be used and features available through an easy-to-use graphical user interface, the PSPro product required that a user create and install device type drivers on a PC and then import the finalized driver into the SAP system.

While SAP provides its own spooling and printing system within the “my SAP Business Suite Solution®,” such system does not provide device drivers for Xerox printers, nor are such device drivers configurable through a graphical user interface as provided in PSPro.

### SUMMARY

Aspects disclosed herein include:

a system comprising a SAP host operating system residing on a computer system; and an ABAP program on the SAP host operating system configured to detect one or more printers interfaced with the SAP for printing on each of the printers and printer feature options available through the printers and to generate a graphical user interface comprising one or more device type drivers including feature options available for each of the printers;

a computer-readable medium containing ABAP instructions for generating, with respect to one or more printers operationally associated with a SAP computer system, a graphical user interface comprising one or more device type drivers including feature options of each of the one or more printers by detecting the printers interfaced with the SAP computer system; determining the device type requirements of the printer(s) for printing on the one or more printers; determining the feature options available on the one or more printers; and generating a graphical user interface comprising one or more device type drivers including feature options of each of the one or more printers; and

an electrostatographic printing system comprising an electrostatographic printing device; a computer system running a SAP operating system operationally connected to the electrostatographic printing device, the computer system comprising an ABAP program configured to detect printers interfaced with the computer system, to determine device type requirements of the electrostatographic printing device for printing on the electrostatographic printing device, and to determine feature options available in respect of the electrostatographic printing device to generate a graphical interface comprising a device type driver including the feature options available for the electrostatographic printing device.

### BRIEF DESCRIPTION OF THE DRAWING

Various of the above mentioned and further features and advantages will be better understood from this description of embodiments thereof, including the attached drawing figure wherein:

FIG. 1 is shown a diagrammatic embodiment of a SAP R/3 architecture system in accordance with an embodiment of the present invention.

### DETAILED DESCRIPTION

In embodiments, there is illustrated a system comprising a SAP host operating system residing on a computer system; and an ABAP program on the SAP host operating system configured to detect one or more printers interfaced with the SAP for printing on the printer and printer feature options available through the printer and to generate a graphical interface comprising one or more device type drivers including feature options available for each of the printers.

In one embodiment, there is described a SAP ABAP utility program designed to configure, create and assign the device type on a SAP host operating system. The configuration tool allows for one or more of media selection, print mode selection (simplex, duplex), output tray selection, various stapling modes, colored fonts, logo and signature fonts, rotated fonts, OMR and MICR fonts, barcodes and printer resident forms. In such embodiment, the SAP ABAP program may be imported for execution. When executed, a user interface, such as a user graphical interface, is provided to allow a user to configure parameters which are necessary to run printing systems connected to the SAP host operating system with enhanced functionality and productivity.

Other functionalities can be configured by means of the user interface generated herein. Using the user interface, in such embodiment a user can make selections of features without any knowledge of the Postscript description language. For example, in respect of Postscript based device types, one can alter behavior with respect to font selection, scalability of fonts to different sizes and conforming document layout of prints between different device types. Further, the media type selection may be both by tray selection or automatic by comparison of requested print to media size (this may enhance productivity in terms of printer capacity, as well as avoid selection of the wrong media by direct tray selection). Through print job initialization of SAPscript and/or LIST formats, changes can be made to print mode (simplex, duplex), media selection (type of stock), stapling and orientation of the print. Selection can also relate to document attributes on a page level, including print mode (simplex, duplex), media selection and orientation. There may also be integration of the Intelligent Barcode Utility (“IBU”) of the SAP application (virtually any barcode can be used by any SAP application), or OCR-A, OCR-B and MICR fonts.

Selections through the graphical user interface may also relate to colored fonts, signature fonts or logo fonts. Colored fonts may be derived from the printer's standard fonts, with Postscript macros being supplied to convert a “black” font into a “colored” font. That is, the color itself, the font base type and the SAP name of the new font object may be selected by the user interface program signature, and/or logo fonts may be created from TIFF images and installed on the printing system, with the device type providing the mechanisms to dynamically access the font.

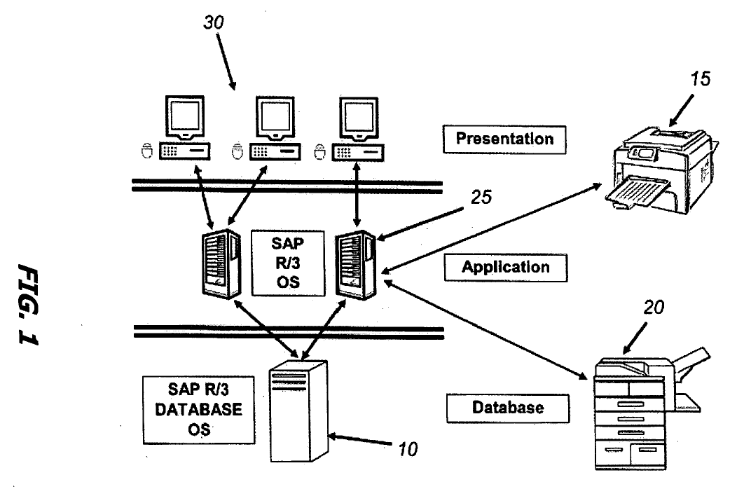

The computer architecture upon which the SAP operating system, and the SAP ABAP utility program for device drivers, runs may be a software-oriented multi-tier client/server architecture. One such multi-tier client/server architecture is shown in FIG. 1. As shown, the application logic level 25 is uncoupled from the presentation level 30 and database level 10. Application level 25 interfaces with printer 15 and electrostatographic copier/printer 20. As such, tasks are distributed in the client/server environment. While a SAP R/3 system may be as set forth in FIG. 1, as would be understood, it is also possible to have a SAP R/3 single-system configuration wherein the presentation, application and database servers execute under the same system, such as a UNIX system. The client/server architecture may also be associated with, for example, OpenVMS, Windows NT, and AS/400.

When the system is operationally connected with more than one printer, the user interface may provide options for each of the printers, which may comprise, for example, an ASCII and/or EBCDIC printer.

In a further embodiment, there is disclosed a computer-readable medium containing ABAP instructions for generating for one or more printers operationally associated with a SAP computer system for graphical user interface comprising one or more device type drivers including feature options of each of the one or more printers; detecting the printers interfaced with the SAP computer system; determining the device type requirements of the printer(s) for printing on one or more printers; determining the feature options available on one or more printers; and generating a graphical user interface comprising one or more device type drivers including feature options of each of the one or more printers.

The printers detected by the foregoing systems described and computer-readable medium may be any printer type, including a liquid ink jet printer, electrostatographic printer, solid ink jet printer, xerographic printer, offset printer, etc.

While the invention has been particularly shown and described with reference to particular embodiments, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
a SAP host operating system residing on a computer system;
an ABAP program on said SAP host operating system configured to detect one or more printers interfaced with the SAP for printing on each of said printers and printer feature options available through said printer, and to generate a graphical user interface comprising one or more device type drivers including feature options available for each of said printers.

2. A system in accordance with claim 1, wherein said SAP host operating system is a SAP R/3 operating system.

3. A system in accordance with claim 1, wherein said feature options include media selection.

4. A system in accordance with claim 1, wherein said feature options are one or more of the options selected from the group consisting of print mode selection, output tray selection, stapling mode, colored fonts, highlighted fonts, logo fonts, signature fonts, rotated fonts, OMR fonts, MICR fonts, barcodes, and printer resident forms.

5. A system in accordance with claim 1, wherein said graphical interface further comprises selection options for different printers.

6. A system in accordance with claim 1, wherein said computer system is a software-oriented multi-tier client/server architecture.

7. A system in accordance with claim 6, wherein said client/server architecture is associated with one or more systems selected from the group consisting of UNIX, OpenVMS, Windows NT and AS/400.

8. A system in accordance with claim 1, wherein said printers are one or more printers selected from the group consisting of ASCII printers and EBCDIC printers.

9. A system in accordance with claim 6, wherein said multi-tier client/server architecture employs a SAP application operating system and a SAP database operating system.

10. A system in accordance with claim 9, wherein said SAP application operating system and SAP database operating system are run at distinct locations in communication with one another.

11. A computer-readable medium containing ABAP instructions for generating, with respect to one or more printers operationally associated with a SAP computer system, a graphical user interface comprising one or more device type drivers including feature options of each of said one or more printers by:
detecting the printers interfaced with said SAP computer system;
determining the device type requirements of said printer(s) for printing on said one or more printers;
determining the feature options available on said one or more printers;
generating a graphical user interface comprising one or more device type drivers including feature options of each of said one or more printers.

12. A computer-readable medium in accordance with claim 11, wherein said SAP computer system uses a SAP R/3 operating system.

13. A computer-readable medium in accordance with claim 11, wherein said feature options include media selection.

14. A computer-readable medium in accordance with claim 11, wherein said feature options are one or more of the options selected from the group consisting of print mode selection, output tray selection, stapling mode, colored fonts, highlighted fonts, logo fonts, signature fonts, rotated fonts, OMR fonts, MICR fonts, barcodes, and printer resident forms.

15. A computer-readable medium in accordance with claim 11, wherein said SAP computer system to which said printers are operationally associated is a software-oriented multi-tier client/server architecture.

16. A computer-readable medium in accordance with claim 15, wherein said client/server architecture is associated with one or more systems selected from the group consisting of UNIX, OpenVMS, Windows NT and AS/400.

17. A computer-readable medium in accordance with claim 16, wherein said client/server architecture is associated with a UNIX-based system.

18. A computer-readable medium in accordance with claim 11, wherein said printers detected are one or more printers selected from the group consisting of ASCII printers and EBCDIC printers.

19. An electrostatographic printing system comprising:
an electrostatographic printing device;
a computer system running a SAP operating system operationally connected to said electrostatographic printing device, said computer system comprising an ABAP program configured to detect printers interfaced with said computer system, to determine device type requirements of said electrostatographic printing device for printing on said electrostatographic printing device, and to determine feature options available in respect of said electrostatographic printing device to generate a graphical interface comprising a device type driver including said feature options available for said electrostatographic printing device.

20. An electrostatographic printing system in accordance with claim 19 wherein said electrostatographic printing device is a xerographic device.
